(19) United States
(12) Patent Application Publication
(10) Pub. No.: US 2025/0084793 A1
(43) Pub. Date: Mar. 13, 2025

(54) TURBINE ENGINE INCLUDING A FUEL SYSTEM

(71) Applicant: General Electric Company, Schenectady, NY (US)

(72) Inventors: Arthur W. Sibbach, Boxford, MA (US); Aaron M. Dziech, Crittenden, KY (US); Scott Alan Schimmels, Miamisburg, OH (US); Brandon W. Miller, Middletown, OH (US)

(21) Appl. No.: 18/463,774

(22) Filed: Sep. 8, 2023

(51) Int. Cl. F02C 7/141; F01K 23/10; F02C 7/16

(52) U.S. Cl. CPC F02C 7/224; F01K 23/10

(57) ABSTRACT

A turbine engine for an aircraft. The turbine engine includes a combustor fluidly coupled to a fuel delivery assembly to receive fuel from the fuel delivery assembly. The fuel is injected into the combustor and combusted in the combustor to generate combustion gases. A condenser is located downstream of the combustor to receive the combustion gases and to condense water. A fuel heat exchanger is thermally coupled to the condenser by at least one heat transfer loop to receive heat from the condenser.

### TECHNICAL FIELD

The present disclosure relates generally to turbine engines, particularly turbine engines for aircraft.

### BACKGROUND

Turbine engines used in aircraft generally include a fan and a core section arranged in flow communication with one another. A combustor is arranged in the core section to generate combustion gases for driving a turbine in the core section of the turbine engine.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1 is a schematic cross-sectional diagram of a turbine engine including a steam system, taken along a longitudinal centerline axis of the turbine engine, according to the present disclosure.

FIG. 2 is a schematic diagram of the turbine engine and a steam system with a thermal transport system according to an embodiment of the present disclosure.

FIG. 3 is a schematic diagram of the turbine engine and the steam system with a thermal transport system according to an embodiment of the present disclosure.

FIG. 4 is a schematic diagram of the turbine engine and the steam system with a thermal transport system according to an embodiment of the present disclosure.

FIG. 5A is a schematic diagram of the turbine engine and the steam system with a thermal transport system according to an embodiment of the present disclosure.

FIG. 5B is a schematic diagram of the turbine engine and the steam system with a thermal transport system according to an embodiment of the present disclosure.

FIG. 6 is a schematic diagram of the turbine engine and the steam system with a thermal transport system according to an embodiment of the present disclosure.

FIG. 7 is a schematic diagram of the turbine engine and the steam system with a thermal transport system according to an embodiment of the present disclosure.

FIG. 8 is a schematic diagram of the turbine engine and the steam system with a thermal transport system according to an embodiment of the present disclosure.

FIG. 9 is a schematic diagram of a thermal transport system according to an embodiment of the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the spirit and the scope of the present disclosure.

As used herein, the terms “first,” “second,” “third,” and “fourth” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbine engine or a vehicle, and refer to the normal operational attitude of the turbine engine or the vehicle. For example, with regard to a turbine engine, forward refers to a position closer to an engine inlet and aft refers to a position closer to an engine nozzle or an exhaust.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

As noted above, a combustor is arranged in the core section to generate combustion gases for driving a turbine in the core section of the turbine engine. Not all of the energy and heat generated by the combustor is used to drive the turbine(s) of the turbine section. Instead, some of the waste heat is exhausted through a jet exhaust nozzle section in a conventional turbine engine. The turbine engine discussed herein includes a steam system that is used to recover some of the energy from the waste heat by generating steam and driving a steam turbine. The steam system includes a condenser that is used to cool combustion products and to condense water from the combustion products. Heat from the combustion products can be absorbed by a heat transfer fluid flowing through the condenser and used to heat other components and/or fluids within the turbine engine. More specifically, in the embodiments discussed herein, the fuel is heated by the heat transfer fluid heated within the condenser. Such systems may be particularly beneficial when the fuel is a cryogenic fuel, such as hydrogen fuel.

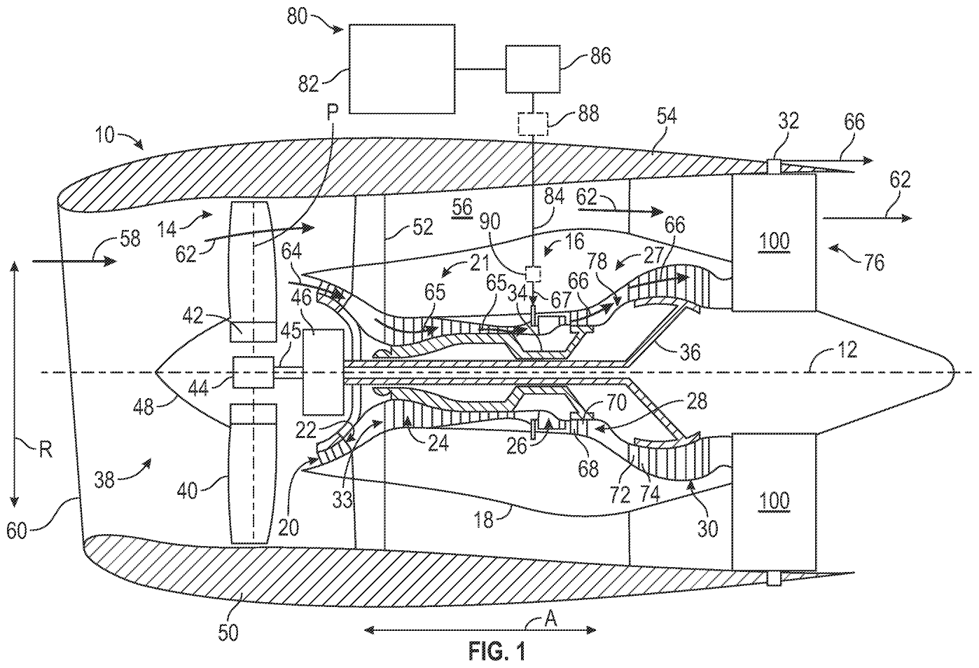

Referring now to the drawings, FIG. 1 is a schematic cross-sectional diagram of a turbine engine 10 including a steam system 100, taken along a longitudinal centerline axis 12 (provided for reference) of the turbine engine 10, according to an embodiment of the present disclosure. As shown in FIG. 1, the turbine engine 10 has an axial direction A (extending parallel to the longitudinal centerline axis 12) and a radial direction R that is normal to the axial direction A. In general, the turbine engine 10 includes a fan section 14 and a core turbine engine 16 disposed downstream from the fan section 14.

The core turbine engine 16 includes an outer casing 18 that is substantially tubular and defines an annular inlet 20. As schematically shown in FIG. 1, the outer casing 18 encases, in serial flow relationship, a compressor section 21 including a booster or a low-pressure compressor (LPC) 22 followed downstream by a high-pressure compressor (HPC) 24, a combustor 26, a turbine section 27, including a high-pressure turbine (HPT) 28, followed downstream by a low-pressure turbine (LPT) 30, and one or more core exhaust nozzles 32. A high-pressure (HP) shaft 34 or a spool drivingly connects the HPT 28 to the HPC 24 to rotate the HPT 28 and the HPC 24 in unison. A low-pressure (LP) shaft 36 drivingly connects the LPT 30 to the LPC 22 to rotate the LPT 30 and the LPC 22 in unison. The compressor section 21, the combustor 26, the turbine section 27, and the one or more core exhaust nozzles 32 together define a core air flow path 33.

For the embodiment depicted in FIG. 1, the fan section 14 includes a fan 38 (e.g., a variable pitch fan) having a plurality of fan blades 40 coupled to a disk 42 in a spaced apart manner. As depicted in FIG. 1, the fan blades 40 extend outwardly from the disk 42 generally along the radial direction R. Each fan blade 40 is rotatable relative to the disk 42 about a pitch axis P by virtue of the fan blades 40 being operatively coupled to an actuator 44 configured to collectively vary the pitch of the fan blades 40 in unison. The fan blades 40, the disk 42, and the actuator 44 are together rotatable about the longitudinal centerline axis 12 via a fan shaft 45 that is powered by the LP shaft 36 across a power gearbox, also referred to as a gearbox assembly 46. The gearbox assembly 46 is shown schematically in FIG. 1. The gearbox assembly 46 includes a plurality of gears for adjusting the rotational speed of the fan shaft 45 and, thus, the fan 38 relative to the LP shaft 36.

Referring still to the exemplary embodiment of FIG. 1, the disk 42 is covered by a rotatable fan hub 48 aerodynamically contoured to promote an airflow through the plurality of fan blades 40. In addition, the fan section 14 includes an annular fan casing or a nacelle 50 that circumferentially surrounds the fan 38 and/or at least a portion of the core turbine engine 16. The nacelle 50 is supported relative to the core turbine engine 16 by a plurality of circumferentially spaced outlet guide vanes 52. Moreover, a downstream section 54 of the nacelle 50 extends over an outer portion of the core turbine engine 16 to define a bypass airflow passage 56 therebetween. The one or more core exhaust nozzles 32 may extend through the nacelle 50 and be formed therein. In this embodiment, the one or more core exhaust nozzles 32 include one or more discrete nozzles that are spaced circumferentially about the nacelle 50. Other arrangements of the core exhaust nozzles 32 may be used including, for example, a single core exhaust nozzle that is annular, or partially annular, about the nacelle 50.

During operation of the turbine engine 10, a volume of air 58 enters the turbine engine 10 through an inlet 60 of the nacelle 50 and/or the fan section 14. As the volume of air 58 passes across the fan blades 40, a first portion of air (bypass air 62) is directed or routed into the bypass airflow passage 56, and a second portion of air (core air 64) is directed or is routed into the upstream section of the core air flow path 33, or, more specifically, into the core inlet 20. The ratio between the first portion of air (bypass air 62) and the second portion of air (core air 64) is known as a bypass ratio. The pressure of the core air 64 is then increased by the LPC 22, generating compressed air 65, and the compressed air 65 is routed through the HPC 24 and further compressed before being directed into the combustor 26, where the compressed air 65 is mixed with fuel 67 and burned to generate combustion gases 66 (combustion products). One or more stages may be used in each of the LPC 22 and the HPC 24, with each subsequent stage further compressing the compressed air 65.

The combustion gases 66 are routed into the HPT 28 and expanded through the HPT 28 where a portion of thermal energy and/or kinetic energy from the combustion gases 66 is extracted via sequential stages of HPT stator vanes 68 that are coupled to the outer casing 18 and HPT rotor blades 70 that are coupled to the HP shaft 34, thus, causing the HP shaft 34 to rotate, thereby supporting operation of the HPC 24. The combustion gases 66 are then routed into the LPT 30 and expanded through the LPT 30. Here, a second portion of thermal energy and/or the kinetic energy is extracted from the combustion gases 66 via sequential stages of LPT stator vanes 72 that are coupled to the outer casing 18 and LPT rotor blades 74 that are coupled to the LP shaft 36, thus, causing the LP shaft 36 to rotate, thereby supporting operation of the LPC 22 and rotation of the fan 38 via the gearbox assembly 46. One or more stages may be used in each of the HPT 28 and the LPT 30.

The combustion gases 66 are subsequently routed through the one or more core exhaust nozzles 32 of the core turbine engine 16 to provide propulsive thrust. Simultaneously with the flow of the core air 64 through the core air flow path 33, the bypass air 62 is routed through the bypass airflow passage 56 before being exhausted from a fan bypass nozzle 76 of the turbine engine 10, also providing propulsive thrust. The HPT 28, the LPT 30, and the one or more core exhaust nozzles 32 at least partially define a hot gas path 78 for routing the combustion gases 66 through the core turbine engine 16.

As noted above, the compressed air 65 (the core air 64) is mixed with the fuel 67 in the combustor 26 to generate a fuel and air mixture, and combusted, generating the combustion gases 66 (combustion products). The fuel 67 can include any type of fuel used for turbine engines, such as, for example, sustainable aviation fuels (SAF) including biofuels, JetA, or other hydrocarbon fuels. The fuel 67 also may be a hydrogen-based fuel (H₂), and, while hydrogen-based fuel may include blends with hydrocarbon fuels, the fuel 67 used herein is preferably unblended, and referred to herein as hydrogen fuel. In some embodiments, the hydrogen fuel may comprise substantially pure hydrogen molecules (i.e., diatomic hydrogen). The fuel 67 may also be a cryogenic fuel. For example, when the hydrogen fuel is used, the hydrogen fuel may be stored in a liquid phase at cryogenic temperatures.

The turbine engine 10 includes a fuel system 80 for providing the fuel 67 to the combustor 26. The fuel system 80 includes a fuel tank 82 for storing the fuel 67 therein, and a fuel delivery assembly 84. The fuel tank 82 can be located on an aircraft (not shown) to which the turbine engine 10 is attached. While a single fuel tank 82 is shown in FIG. 1, the fuel system 80 can include any number of fuel tanks 82, as desired. The fuel delivery assembly 84 delivers the fuel 67 from the fuel tank 82 to the combustor 26. The fuel delivery assembly 84 includes one or more lines, conduits, pipes, tubes, etc., configured to carry the fuel 67 from the fuel tank 82 to the combustor 26. The fuel delivery assembly 84 also includes a pump 86 to induce the flow of the fuel 67 through the fuel delivery assembly 84 to the combustor 26. In this way, the pump 86 pumps the fuel 67 from the fuel tank 82, through the fuel delivery assembly 84, and into the combustor 26. The fuel system 80 and, more specifically, the fuel tank 82 and the fuel delivery assembly 84, either collectively or individually, may be a fuel source for the combustor 26.

In some embodiments, for example, when the fuel 67 is a hydrogen fuel, the fuel system 80 includes one or more vaporizers 88 (illustrated by dashed lines) and a metering valve 90 (illustrated by dashed lines) in fluid communication with the fuel delivery assembly 84. In this example, the hydrogen fuel is stored in the fuel tank 82 as liquid hydrogen fuel. The one or more vaporizers 88 heat the liquid hydrogen fuel flowing through the fuel delivery assembly 84. The one or more vaporizers 88 are positioned in the flow path of the fuel 67 between the fuel tank 82 and the combustor 26, and are located downstream of the pump 86. The one or more vaporizers 88 are in thermal communication with at least one heat source, such as, for example, waste heat from the turbine engine 10 and/or from one or more systems of the aircraft (not shown). The one or more vaporizers 88 heat the liquid hydrogen fuel and convert the liquid hydrogen fuel into a gaseous hydrogen fuel within the one or more vaporizers 88. The fuel delivery assembly 84 directs the gaseous hydrogen fuel into the combustor 26.

The metering valve 90 is positioned downstream of the one or move vaporizers 88 and the pump 86. The metering valve 90 receives hydrogen fuel in a substantially completely gaseous phase, or in a substantially completely supercritical phase. The metering valve 90 provides the flow of fuel to the combustor 26 in a desired manner. More specifically, the metering valve 90 provides a desired volume of hydrogen fuel at, for example, a desired flow rate, to a fuel manifold that includes one or more fuel injectors that inject the hydrogen fuel into the combustor 26. The fuel system 80 can include any components for supplying the fuel 67 from the fuel tank 82 to the combustor 26, as desired.

The turbine engine 10 includes a steam system 100 in fluid communication with the one or more core exhaust nozzles 32 and the fan bypass nozzle 76. The steam system 100 extracts steam from the combustion gases 66 as the combustion gases 66 flow through the steam system 100, as detailed further below.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, and/or turboprop engines.

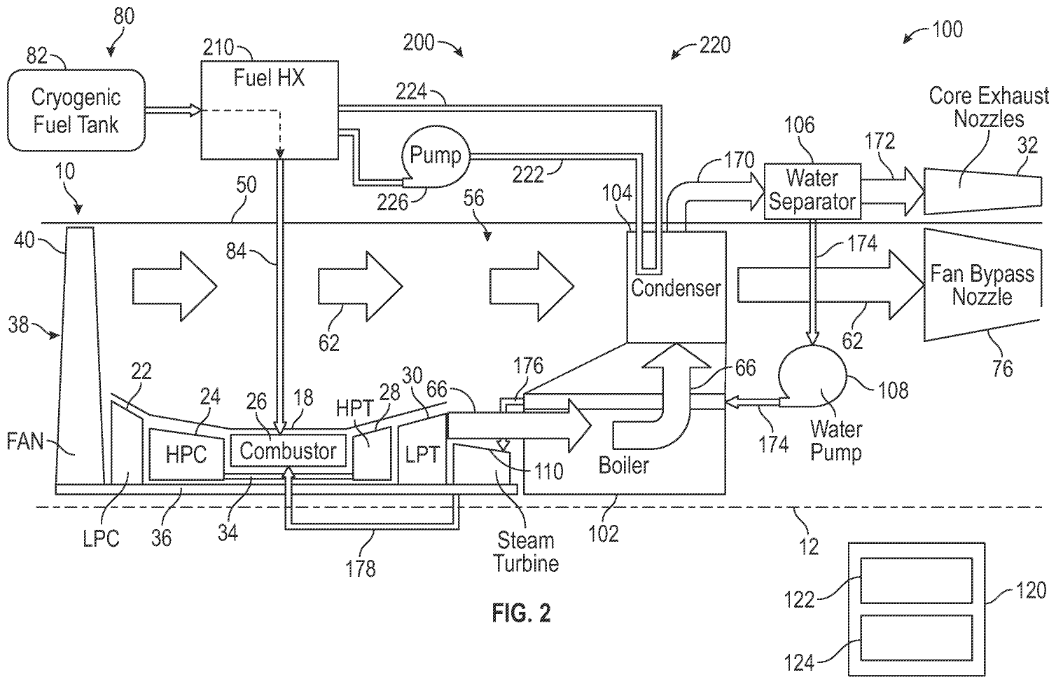

FIG. 2 is a schematic diagram of the turbine engine 10 and the steam system 100 of FIG. 1 having a thermal transport system 200 according to the present disclosure. For clarity with the other thermal transport systems discussed herein, the thermal transport system 200 of this embodiment will be referred to as a first thermal transport system 200. The turbine engine 10 is shown schematically in FIG. 2 and some components are not shown in FIG. 2. The steam system 100 includes a boiler 102, a condenser 104, a water separator 106, a water pump 108, and a steam turbine 110.

The boiler 102 is a heat exchanger that vaporizes liquid water from a water source to generate steam or water vapor, as detailed further below. The boiler 102 is thus a steam source. In particular, the boiler 102 is an exhaust gas-water heat exchanger. The boiler 102 is in fluid communication with the hot gas path 78 (FIG. 1) and is positioned downstream of the LPT 30. The boiler 102 is also in fluid communication with the water pump 108, as detailed further below. The boiler 102 can include any type of boiler or heat exchanger for extracting heat from the combustion gases 66 and vaporizing liquid water into steam or water vapor as the liquid water and the combustion gases 66 flow through the boiler 102.

The condenser 104 is a heat exchanger that further cools the combustion gases 66 as the combustion gases 66 flow through the condenser 104, as detailed further below. In particular, the condenser 104 is an air-exhaust gas heat exchanger. The condenser 104 is in fluid communication with the boiler 102 and, in this embodiment, is positioned within the bypass airflow passage 56. The condenser 104, however, may be positioned elsewhere and thermally connected to other cooling sources, such as being thermally connected to the fuel 67 to transfer heat to the fuel 67, using for example, the thermal transport systems discussed herein. The condenser 104 can include any type of condenser for condensing water from the exhaust (e.g., the combustion gases 66).

The water separator 106 is in fluid communication with the condenser 104 for receiving cooled exhaust (combustion gases 66) having condensed water entrained therein. The water separator 106 is also in fluid communication with the one or more core exhaust nozzles 32 and with the water pump 108. The water separator 106 includes any type of water separator for separating water from the exhaust. For example, the water separator 106 can include a cyclonic separator that uses vortex separation to separate the water from the air. In such embodiments, the water separator 106 generates a cyclonic flow within the water separator 106 to separate the water from the cooled exhaust. In FIG. 2, the water separator 106 is schematically depicted as being in the nacelle 50, but the water separator 106 could be located at other locations within the turbine engine 10, such as, for example, radially inward of the nacelle 50, closer to the core turbine engine 16. The water separator 106 may be driven to rotate by one of the engine shafts, such as the HP shaft 34 or the LP shaft 36. As noted above, the boiler 102 receives liquid water from a water source to generate steam or water vapor. In the embodiment depicted in FIG. 2, the condenser 104 and the water separator 106, individually or collectively, are the water source for the boiler 102.

The water pump 108 is in fluid communication with the water separator 106 and with the boiler 102. The water pump 108 is in fluid communication with the condenser 104 via the water separator 106. The water pump 108 may be any suitable pump, such as a centrifugal pump or a positive displacement pump. The water pump 108 directs the separated liquid water through the boiler 102 where it is converted back to steam. This steam is sent through the steam turbine 110 then injected into core air flow path 33, such as into the combustor 26.

In operation, the combustion gases 66, also referred to as exhaust, flow from the LPT 30 into the boiler 102. The combustion gases 66 transfer heat into the water 174 (e.g., in liquid form) within the boiler 102, as detailed further below. The combustion gases 66 then flow into the condenser 104. The condenser 104 condenses the water 174 (e.g., in liquid form) from the combustion gases 66. The bypass air 62 flows through the bypass airflow passage 56 and over or through the condenser 104 and extracts heat from the combustion gases 66, cooling the combustion gases 66 and condensing the water 174 from the combustion gases 66, to generate an exhaust-water mixture 170. The bypass air 62 is then exhausted out of the turbine engine 10 through the fan bypass nozzle 76 to generate thrust, as detailed above. The condenser 104 thus may be positioned in bypass airflow passage 56.

The exhaust-water mixture 170 flows into the water separator 106. The water separator 106 separates the water 174 from the exhaust of the exhaust-water mixture 170 to generate separate exhaust 172 and the water 174. The exhaust 172 is exhausted out of the turbine engine 10 through the one or more core exhaust nozzles 32 to generate thrust, as detailed above. The boiler 102, the condenser 104, and the water separator 106 thus also define a portion of the hot gas path 78 (see FIG. 1) for routing the combustion gases 66, the exhaust-water mixture 170, and the exhaust 172 through the steam system 100 of the turbine engine 10.

The water pump 108 pumps the water 174 (e.g., in liquid form) through one or more water lines (as indicated by the arrow for the water 174 in FIG. 2) and the water 174 flows through the boiler 102. As the water 174 flows through the boiler 102, the combustion gases 66 flowing through the boiler 102 transfer heat into the water 174 to vaporize the water 174 and to generate the steam 176 (e.g., vapor). The steam turbine 110 includes one or more stages of steam turbine blades (not shown) and steam turbine stators (not shown). The steam 176 flows from the boiler 102 into the steam turbine 110, through one or more steam lines (as indicated by the arrow for the steam 176 in FIG. 2), causing the steam turbine blades of the steam turbine 110 to rotate, thereby generating additional work in an output shaft (e.g., one of the core shafts) connected to the turbine blades of the steam turbine 110.

As noted above, the core turbine engine 16 includes shafts, also referred to as core shafts, coupling various rotating components of the core turbine engine 16 and other thrust producing components such as the fan 38. In the core turbine engine 16 shown in FIG. 1, these core shafts include the HP shaft 34 and the LP shaft 36. The steam turbine 110 is coupled to one of the core shafts of the core turbine engine 16, such as the HP shaft 34 or the LP shaft 36. In the illustrated embodiment, the steam turbine 110 is coupled to the LP shaft 36. As the steam 176 flows from the boiler 102 through the steam turbine 110, the kinetic energy of this gas is converted by the steam turbine 110 into mechanical work in the LP shaft 36. The reduced temperature steam (as steam 178) exiting the steam turbine 110 is then injected into the core air flow path 33, such as into the combustor 26, upstream of the combustor 26, or downstream of the combustor 26. The steam 178 flows through one or more steam lines from the steam turbine 110 to the core air flow path 33. The steam 178 injected into the core air flow path 33 adds mass flow to the core air 64 such that less core air 64 is needed to produce the same amount of work through the turbine section 27. In this way, the steam system 100 extracts additional work from the heat in exhaust gas that would otherwise be wasted.

The turbine engine 10 may also include an engine controller 120. The engine controller 120 is configured to operate various aspects of the turbine engine 10, including, in the embodiments discussed herein, the water pump 108, a fuel bypass valve 214, and a movement mechanism 238 of an accumulator 230. The engine controller 120 may be a Full Authority Digital Engine Control (FADEC). In this embodiment, the engine controller 120 is a computing device having one or more processors 122 and one or more memories 124. The processor 122 can be any suitable processing device, including, but not limited to, a microprocessor, a microcontroller, an integrated circuit, a logic device, a programmable logic controller (PLC), an application-specific integrated circuit (ASIC), and/or a Field Programmable Gate Array (FPGA). The memory 124 can include one or more computer-readable media, including, but not limited to, non-transitory computer-readable media, a computer-readable non-volatile medium (e.g., a flash memory), a RAM, a ROM, hard drives, flash drives, and/or other memory devices.

The memory 124 can store information accessible by the processor 122, including computer-readable instructions that can be executed by the processor 122. The instructions can be any set of instructions or a sequence of instructions that, when executed by the processor 122, causes the processor 122 and the engine controller 120 to perform operations. In some embodiments, the instructions can be executed by the processor 122 to cause the processor 122 to complete any of the operations and functions for which the engine controller 120 is configured, as will be described further below. The instructions can be software written in any suitable programming language, or can be implemented in hardware. Additionally, and/or alternatively, the instructions can be executed in logically and/or virtually separate threads on the processor 122. The memory 124 can further store data that can be accessed by the processor 122.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between components and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Heating the fuel 67 (FIG. 1) prior to injecting the fuel 67 into the combustor 26 may be used for various reasons. Some fuels, such as hydrocarbon-based fuels may be heated, for example, to prevent ice formation or for performance benefits. Other fuels, such as cryogenic fuels, may be heated and vaporized (converted from a liquid state in which the cryogenic fuel is stored to a vapor state for combustion), prior to being injected into the combustor 26. As noted above, the embodiments discussed herein utilize a thermal transport system to transfer heat from the turbine engine 10 and to use that heat to help heat the fuel 67. The following discussion makes reference to cryogenic fuel and, more specifically, hydrogen fuel, but the thermal transport systems discussed herein may be applicable to other fuel systems.

The fuel tank 82 is configured to hold the hydrogen fuel at least partially within the liquid phase and is configured to provide hydrogen fuel to the fuel delivery assembly 84 substantially completely in the liquid phase, such as completely in the liquid phase. The fuel tank 82 has a fixed volume and contains a volume of the hydrogen fuel in the liquid phase (e.g., liquid hydrogen fuel). As the fuel tank 82 provides hydrogen fuel to the fuel delivery assembly 84 substantially completely in the liquid phase, the volume of the liquid hydrogen fuel in the fuel tank 82 decreases and the remaining volume in the fuel tank 82 is made up by, for example, hydrogen substantially completely in the gaseous phase (gaseous hydrogen). As used herein, the term “substantially completely” is used to describe a phase of the hydrogen fuel refers to at least 99% by mass of the described portion of the hydrogen fuel being in the stated phase, such as at least 97.5%, such as at least 95%, such as at least 92.5%, such as at least 90%, such as at least 85%, or such as at least 75% by mass of the described portion of the hydrogen fuel being in the stated phase.

To store the hydrogen fuel substantially completely in the liquid phase, the hydrogen fuel is stored in the fuel tank 82 at very low (cryogenic) temperatures, and, thus, the fuel tank 82 may also be referred to herein as a cryogenic fuel tank. For example, the hydrogen fuel may be stored in the fuel tank 82 at about −253 degrees Celsius (twenty Kelvin) or less at atmospheric pressure, or at other temperatures and pressures to maintain the hydrogen fuel substantially completely in the liquid phase. In some embodiments, the hydrogen fuel may be stored in the fuel tank 82 at temperatures from −259 degrees Celsius (fourteen Kelvin) to −243 degrees Celsius (thirty Kelvin), and, more preferably, from −253 degrees Celsius (twenty Kelvin) to −243 degrees Celsius (thirty Kelvin). To store the hydrogen fuel in the liquid phase, the fuel tank 82 stores and maintains the hydrogen cryogenically and may be a cryostat. The fuel tank 82 may thus be, for example, a dual wall tank, including an inner vessel (e.g., an inner cryogenic liquid tank) and an outer vessel (e.g., a vacuum vessel). The inner vessel may be positioned within the outer vessel with a gap formed between the inner vessel and the outer vessel. To provide thermal isolation for the inner vessel, the gap may be under a vacuum. The gap may include a void space or be an entirely void space, but, alternatively, the gap may include multi-layer insulation (MLI), such as aluminized polyester films (e.g., aluminized Mylar®), for example.

The turbine engine 10 shown in FIG. 2 includes the thermal transport system 200 that may be used to transfer heat from the steam system 100 to the fuel system 80. The first thermal transport system 200 includes a fuel heat exchanger 210 fluidly connected to the fuel delivery assembly 84. As the fuel 67 flows from the fuel tank 82 to the combustor 26, the fuel 67 is routed through the fuel heat exchanger 210 and absorbs (receives) heat from a heat transfer fluid (also referred to as a heat transfer medium) that also flows through the fuel heat exchanger 210. In some embodiments, the fuel heat exchanger 210 may be one of the vaporizers 88 discussed above. The fuel heat exchanger 210 may also be in addition to the vaporizers 88. The fuel heat exchanger 210 may be any suitable heat exchanger, including, for example, a plate heat exchanger or a tubular heat exchanger, such as a tube and shell heat exchanger. The fuel heat exchanger 210 thus includes a fluid flow path for the heat transfer fluid.

The first thermal transport system 200 includes a heat transfer loop 220 that thermally couples the condenser 104 with the fuel heat exchanger 210 to transfer heat from the condenser 104 with the fuel heat exchanger 210. More specifically, the heat transfer fluid flows through the heat transfer loop 220, and the heat transfer loop 220 is fluidly connected to the fuel heat exchanger 210 and the condenser 104 to circulate the heat transfer fluid between the fuel heat exchanger 210 and the condenser 104. The condenser 104 includes a fluid flow path for the heat transfer fluid, and, as heat transfer fluid flows through the condenser 104, the heat transfer fluid is heated by the combustion gases 66 also flowing through the condenser 104. The heat transfer fluid thus absorbs heat from the combustion gases 66.

The heat transfer loop 220 includes a supply line 222. The supply line 222 is fluidly connected to each of the condenser 104 and the fuel heat exchanger 210. The heat transfer fluid, after being heated by the combustion gases 66, flows through the supply line 222 from the condenser 104 to the fuel heat exchanger 210 where, as discussed above, heat is transferred from the heat transfer fluid to the fuel 67.

The heat transfer loop 220 also includes a return line 224 fluidly connected to each of the fuel heat exchanger 210 and the condenser 104. The heat transfer fluid, after transferring heat to the fuel 67, flows through the return line 224 from the fuel heat exchanger 210 to the condenser 104 where, as discussed above, heat is transferred from the combustion gases 66 to the heat transfer fluid.

The heat transfer loop 220 also includes a heat transfer fluid pump 226. The heat transfer fluid pump 226 induces the flow of the heat transfer fluid through the heat transfer loop 220 between the fuel heat exchanger 210 and the condenser 104. The heat transfer fluid pump 226 may be located at any suitable location within the heat transfer loop 220, but, in this embodiment, the heat transfer fluid pump 226 is located in the supply line 222. Any pump suitable for the heat transfer fluid may be used, such as, for example, a positive displacement pump, a centrifugal pump, or a compressor. The heat transfer fluid may be a suitable working fluid that is used to transfer heat between the environments of the combustion gases 66 and the fuel 67. Suitable heat transfer fluids include, for example, helium, nitrogen, supercritical carbon dioxide, a silicon-based heat transfer fluid (e.g., Syltherm™ 800 or Syltherm™ XLT, each produced by Dow of Midland, Michigan, USA), or sulfur hexafluoride.

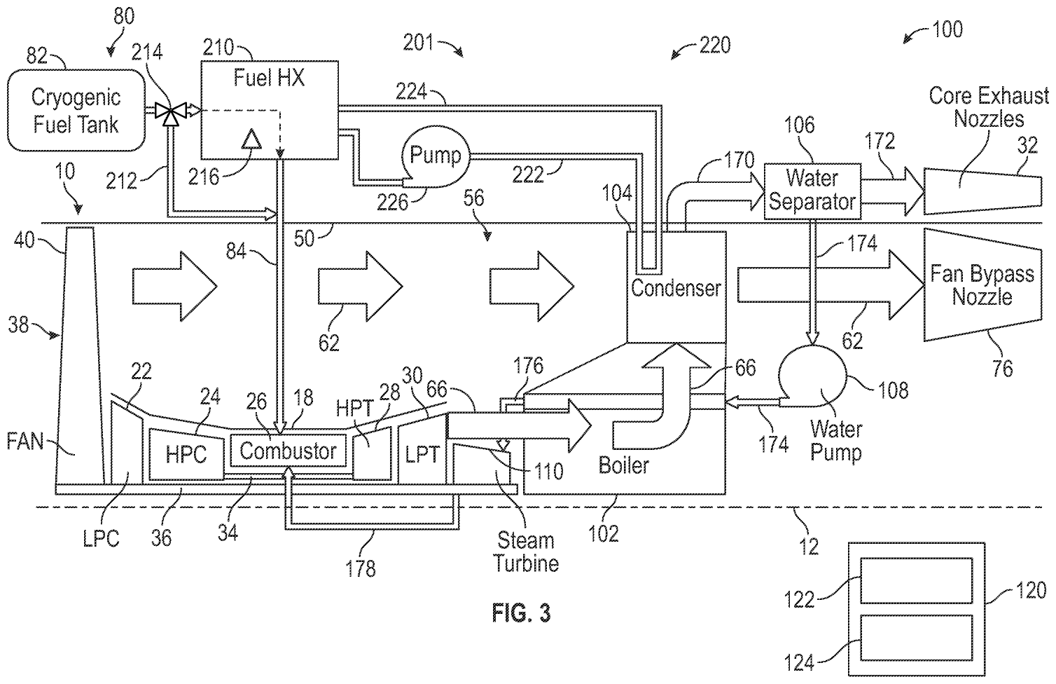

FIG. 3 is a schematic diagram of the turbine engine 10 and the steam system 100 of FIG. 1 having a thermal transport system 201, according to the present disclosure. For clarity with the other thermal transport systems discussed herein, the thermal transport system 201 of this embodiment will be referred to as a second thermal transport system 201. The second thermal transport system 201 is similar to the first thermal transport system 200 discussed above with reference to FIG. 2. The same reference numerals will be used for components of the second thermal transport system 201 that are the same as or similar to the components of the first thermal transport system 200 discussed above. The description of these components above also applies to this embodiment, and a detailed description of these components is omitted here.

There may be instances when heating the fuel 67 with the heat transfer fluid is not desirable. Such conditions include startup when the heat from the combustion gases 66 is not sufficiently hot enough to heat the water 174 flowing through the boiler 102 and also to heat the heat transfer fluid. Accordingly, the fuel system 80 (and second thermal transport system 201) of this embodiment includes a fuel bypass line 212 (i.e., a fuel bypass flow path) that fluidly connects a portion of the fuel delivery assembly 84 upstream of the fuel heat exchanger 210 with a portion of the fuel delivery assembly 84 downstream of the fuel heat exchanger 210, thus, bypassing the fuel heat exchanger 210. The fuel system 80 is, thus, selectively operable to redirect the fuel 67, or a portion thereof, and to bypass the fuel heat exchanger 210.

The fuel bypass line 212 includes a fuel bypass valve 214 located in the fuel bypass line 212 and the fuel delivery assembly 84. The fuel bypass valve 214 is operable to open and to direct the fuel 67 through the fuel bypass line 212, bypassing the fuel heat exchanger 210, and, thus, the fuel bypass valve 214 selectively operates the fuel system 80 to bypass the fuel heat exchanger 210. The fuel bypass valve 214 may be any suitable valve including a three-way valve. The fuel bypass valve 214 may also be a flow control valve (e.g., a proportional control valve) that directs a portion of the fuel 67 and/or controls the flow of the fuel 67 through the fuel heat exchanger 210 and the fuel bypass line 212. The fuel bypass valve 214 may be any suitable valve including, for example, an electrically operable valve, a hydraulically operable valve, or a pneumatically operable valve. When the fuel bypass valve 214 is hydraulically operable, the hydraulic fluid may be suitable fluids of the turbine engine 10 including, for example, the fuel 67, lubrication oil, and the like.

The fuel heat exchanger 210 or another portion of the heat transfer loop 220, such as the supply line 222, may include a temperature sensor 216. The temperature sensor 216 may be used to determine the temperature of the fuel heat exchanger 210 and/or the heat transfer fluid. The temperature sensor 216 is communicatively coupled to the engine controller 120 to receive an input indicative of a temperature detected by the temperature sensor 216. The engine controller 120 may be configured to receive an input from the temperature sensor 216 indicating the temperature of the compressor section 21 and/or the heat transfer fluid and operate fuel bypass valve 214 to bypass the fuel heat exchanger 210 based on the input (temperature) received from the temperature sensor 216.

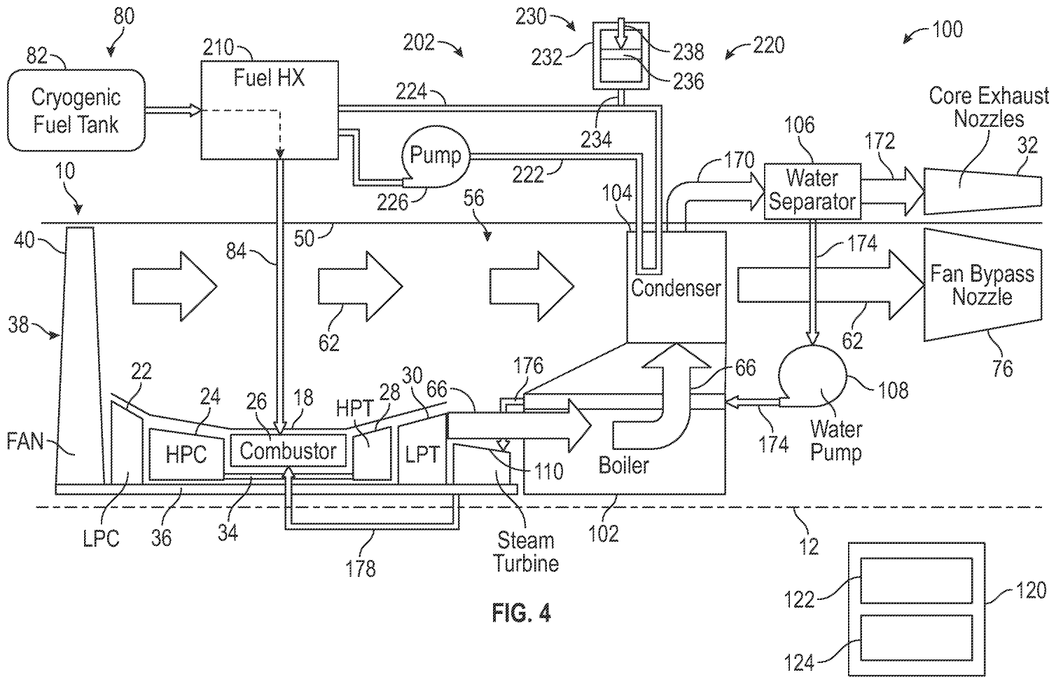

FIG. 4 is a schematic diagram of the turbine engine 10 and the steam system 100 of FIG. 1 having a thermal transport system 202, according to the present disclosure. For clarity with the other thermal transport systems discussed herein, the thermal transport system 202 of this embodiment will be referred to as a third thermal transport system 202. The third thermal transport system 202 is similar to the first thermal transport system 200 discussed above with reference to FIG. 2. The same reference numerals will be used for components of the third thermal transport system 202 that are the same as or similar to the components of the first thermal transport system 200 discussed above. The description of these components above also applies to this embodiment, and a detailed description of these components is omitted here.

The heat transfer loop 220 of this embodiment also includes an accumulator 230. The accumulator 230 may be used to regulate the volume of the heat transfer fluid within the heat transfer loop 220 and/or the pressure of the heat transfer fluid within the heat transfer loop 220. The accumulator 230 may be particularly advantageous when the heat transfer fluid is a heat transfer fluid that has a propensity to change phases under the operational conditions of the heat transfer loop 220 discussed herein. The accumulator 230 may be used to regulate the pressure of the heat transfer fluid and maintain the heat transfer fluid in the desired phase. For example, supercritical carbon dioxide is one such heat transfer fluid that has a propensity to change phases and accumulator 230 may be used to regulate the pressure of the heat transfer fluid in the heat transfer loop 220 to maintain carbon dioxide in a supercritical state. The accumulator 230 includes a fluid reservoir 232, such as a tank that is fluidly connected to the heat transfer loop 220 by an accumulator line 234. The accumulator 230 may be fluidly connected by the accumulator line 234 at any suitable location within the heat transfer loop 220, but, in this embodiment, the accumulator 230 is fluidly connected to the return line 224.

The accumulator 230 may be a variable volume accumulator that includes, for example, a diaphragm 236 or other suitable movable component to change the volume of the fluid reservoir 232. The diaphragm 236 may be moved by a movement mechanism 238. For example, the diaphragm 236 may be actively controlled by an actuator as the movement mechanism 238 to move the diaphragm 236. Suitable actuators include, for example, an electrical actuator or a hydraulic actuator. When a hydraulic actuator is used, the hydraulic fluid may be suitable fluids of the turbine engine 10 including, for example, the fuel 67, lubrication oil, and the like. When the diaphragm 236 is actively controlled, a pressure sensor or other sensor is located within the heat transfer loop 220 and communicatively connected to the engine controller 120. The engine controller 120 is communicatively and operatively connected to the movement mechanism 238, and the engine controller 120 is configured to operate the movement mechanism 238 and to move the diaphragm 236 based on the input received from the sensor. Alternatively, the diaphragm 236 may be passively controlled, in which the case, the movement mechanism 238 is a passive mechanism (e.g., a biasing member) such as a spring or a bellows that exerts a desired force (i.e., a biasing force) on the diaphragm 236 such that the volume of the accumulator 230 increases in response to an increase in pressure of the heat transfer fluid in the heat transfer loop 220 and decreases in volume in response to a decrease in pressure of the heat transfer fluid in the heat transfer loop 220.

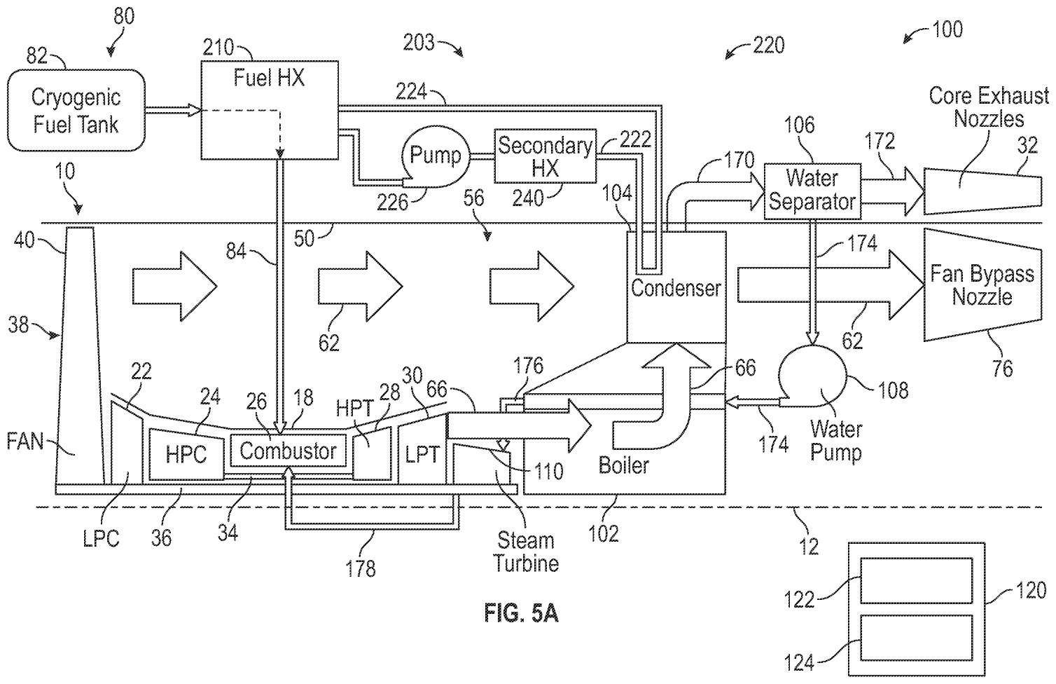

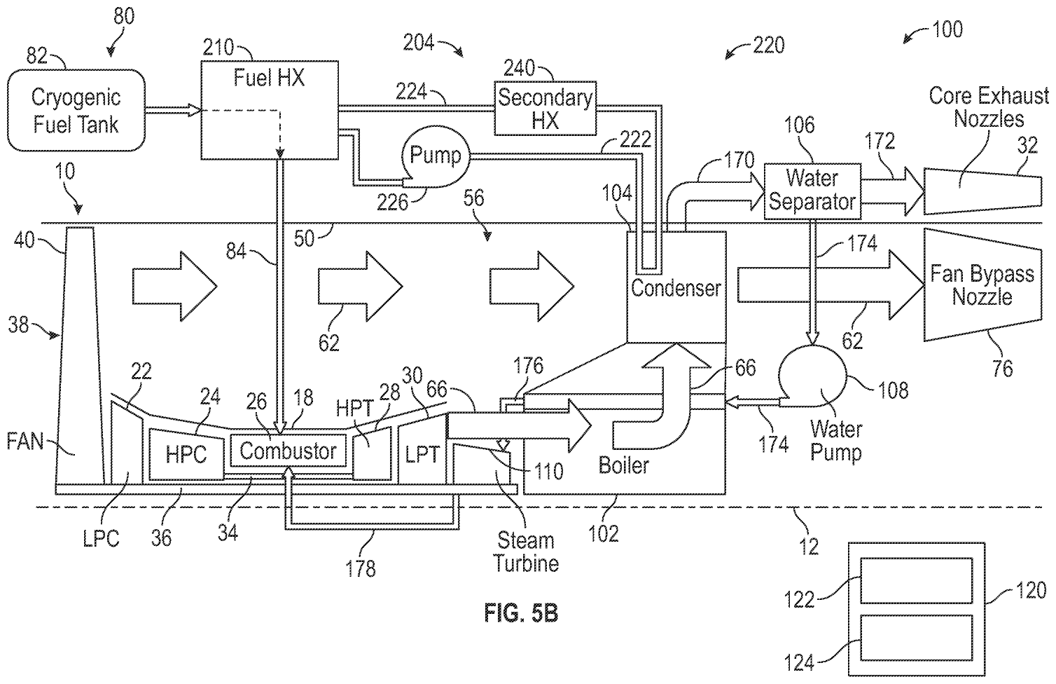

FIG. 5A is a schematic diagram of the turbine engine 10 and the steam system 100 of FIG. 1 having a thermal transport system 203, according to the present disclosure. For clarity with the other thermal transport systems discussed herein, the thermal transport system 203 of this embodiment will be referred to as a fourth thermal transport system 203. The fourth thermal transport system 203 is similar to the first thermal transport system 200 discussed above with reference to FIG. 2. The same reference numerals will be used for components of the fourth thermal transport system 203 that are the same as or similar to the components of the first thermal transport system 200 discussed above. The description of these components above also applies to this embodiment, and a detailed description of these components is omitted here.

The heat transfer fluid and the heat transfer loop 220 may also be used to transfer heat to or from other components of the turbine engine 10. The temperature of the heat transfer fluid exiting the condenser 104 may be, for example, less than two hundred twelve degrees Fahrenheit (212° F.) and thus may be suitable for use as a heat sink for other systems within the turbine engine 10, such as lubrication oil systems. The heat transfer loop 220 is thus fluidly connected to another device or a system and, more specifically, a secondary heat exchanger 240 of the other device or the system. The heat transfer fluid flows through the secondary heat exchanger 240 and transfers heat to or absorbs heat from the other device or the system. The secondary heat exchanger 240 is located in series with the condenser 104. The secondary heat exchanger 240 may be located at any suitable location within the heat transfer loop 220, but, in this embodiment, the secondary heat exchanger 240 is located in the supply line 222, downstream of the condenser 104 and upstream of the fuel heat exchanger 210. The secondary heat exchanger 240 is also located upstream of the heat transfer fluid pump 226. The heat transfer fluid may be used to absorb heat from the other device or the system and, thus, be used to cool the other device or the system. The other device may be, for example, motor generators. The other system may include, for example, an oil system with the secondary heat exchanger 240 being an oil cooler used to cool oil, such as lubrication oil, a cooling air system, or a heat exchanger located downstream of the HPC 24 or in the later stages of the HPC 24 to cool the compressed air.

FIG. 5B is a schematic diagram of the turbine engine 10 and the steam system 100 of FIG. 1 having a thermal transport system 204, according to the present disclosure. For clarity with the other thermal transport systems discussed herein, the thermal transport system 204 of this embodiment will be referred to as a fifth thermal transport system 204. The fifth thermal transport system 204 is similar to the fourth thermal transport system 203 discussed above with reference to FIG. 5A. The same reference numerals will be used for components of the fifth thermal transport system 204 that are the same as or similar to the components of the fourth thermal transport system 203 discussed above. The description of these components above also applies to this embodiment, and a detailed description of these components is omitted here. In the fourth thermal transport system 203 of FIG. 5A, the secondary heat exchanger 240 is located in the supply line 222, downstream of the condenser 104 and upstream of the fuel heat exchanger 210. As noted above, however, the secondary heat exchanger 240 may be located at other positions within the heat transfer loop 220. The secondary heat exchanger 240 of this embodiment is located in the return line 224, downstream of the fuel heat exchanger 210 and upstream of the condenser 104.

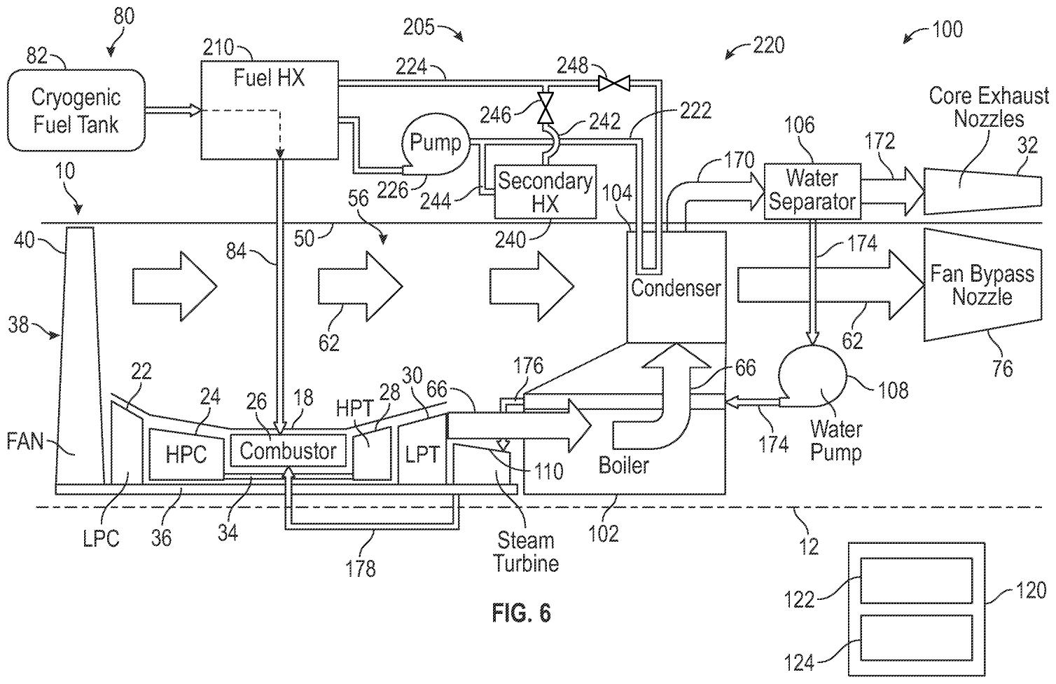

FIG. 6 is a schematic diagram of the turbine engine 10 and the steam system 100 of FIG. 1 having a thermal transport system 205, according to the present disclosure. For clarity with the other thermal transport systems discussed herein, the thermal transport system 205 of this embodiment will be referred to as a sixth thermal transport system 205. The sixth thermal transport system 205 is similar to the fourth thermal transport system 203 discussed above with reference to FIG. 5A. The same reference numerals will be used for components of the sixth thermal transport system 205 that are the same as or similar to the components of the fourth thermal transport system 203 discussed above. The description of these components above also applies to this embodiment, and a detailed description of these components is omitted here.

In the fourth thermal transport system 203, the secondary heat exchanger 240 is located in series with the condenser 104, but other arrangements of the secondary heat exchanger 240 may be used. In this embodiment, the secondary heat exchanger 240 is located in parallel with the condenser 104. The secondary heat exchanger 240 may be fluidly connected to the return line 224 by a secondary input line 242. The heat transfer fluid flows from the fuel heat exchanger 210 and into the secondary heat exchanger 240 via the secondary input line 242. After absorbing heat in the secondary heat exchanger 240, the heat transfer fluid flowing through the secondary heat exchanger 240 then flows back into the supply line 222 of the heat transfer loop 220 via a secondary output line 244. The secondary output line 244 is fluidly connected to the supply line 222 at a position upstream of the condenser 104 and downstream of the fuel heat exchanger 210 and, more specifically, upstream of the heat transfer fluid pump 226.

The flow of the heat transfer fluid through the secondary heat exchanger 240 and the condenser 104 may be regulated by one or more flow control valves. More specifically, in this embodiment, a secondary flow control valve 246 is located in the secondary input line 242 to control the flow of the heat transfer fluid flowing through the secondary heat exchanger 240. Likewise, a primary flow control valve 248 is located in the return line 224 to control the flow of the heat transfer fluid flowing through the condenser 104. The primary flow control valve 248 may be located upstream of the condenser 104 and downstream of the location where the secondary input line 242 fluidly connects to the return line 224. Any suitable flow control valve may be used as the secondary flow control valve 246 or the primary flow control valve 248. Such flow control valves may have a closed position and a plurality of open positions including a fully open position. The flow control valves may be electrically operable valves, hydraulically operable valves, or pneumatically operable valves. When the flow control valves are hydraulically operable, the hydraulic fluid may be suitable fluids of the turbine engine 10 including, for example, the fuel 67, lubrication oil, and the like.

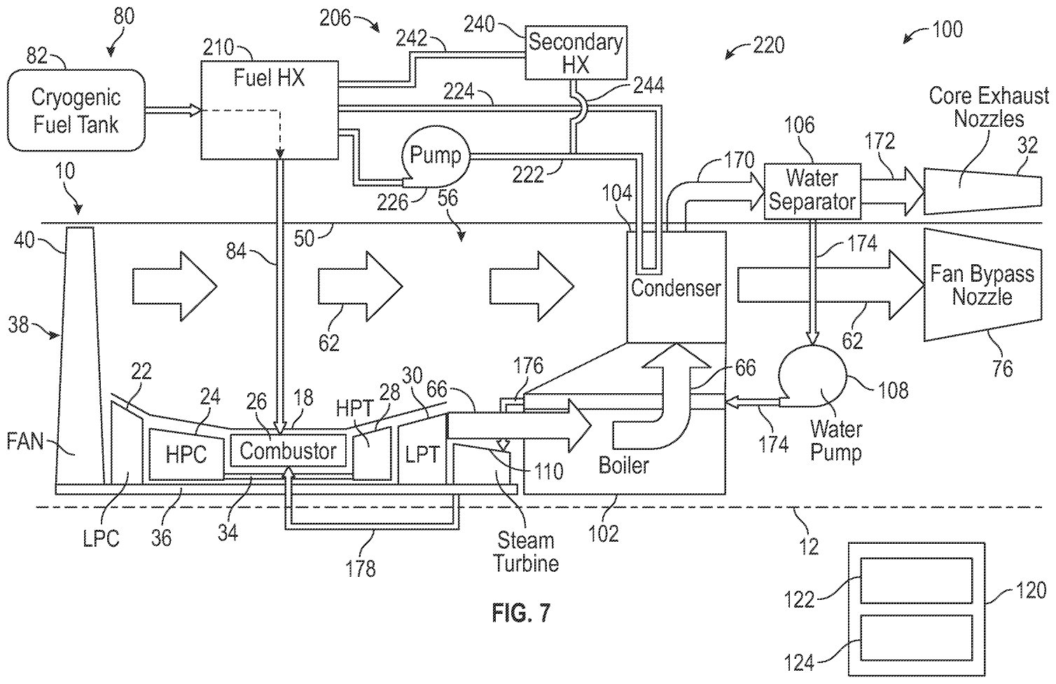

FIG. 7 is a schematic diagram of the turbine engine 10 and the steam system 100 of FIG. 1 having a thermal transport system 206, according to the present disclosure. For clarity with the other thermal transport systems discussed herein, the thermal transport system 206 of this embodiment will be referred to as a seventh thermal transport system 206. The seventh thermal transport system 206 is similar to the fourth thermal transport system 203 discussed above with reference to FIG. 5A. The same reference numerals will be used for components of the seventh thermal transport system 206 that are the same as or similar to the components of the fourth thermal transport system 203 discussed above. The description of these components above also applies to this embodiment, and a detailed description of these components is omitted here.

The secondary heat exchanger 240 may also be fluidly connected to the secondary heat exchanger 240 in other arrangements. In this embodiment, the fuel heat exchanger 210 includes a plurality of outlets for the heat transfer fluid. The return line 224 may be fluidly connected to one outlet to supply the heat transfer fluid, as discussed above, to the condenser 104, and the secondary input line 242 may be connected to the second outlet to supply the heat transfer fluid, as discussed above, to the secondary heat exchanger 240. The outlets may be connected to different positions of the flow path for the heat transfer fluid through the fuel heat exchanger 210 to provide the heat transfer fluid to the condenser 104 and the secondary heat exchanger 240. For example, the first outlet may be connected to the return line 224 at a position upstream of the second outlet connected to the secondary input line 242 to provide the heat transfer fluid to the condenser 104 at a lower temperature than the secondary heat exchanger 240. Although not shown in FIG. 7, the secondary flow control valve 246 and the primary flow control valve 248 may be used in this embodiment.

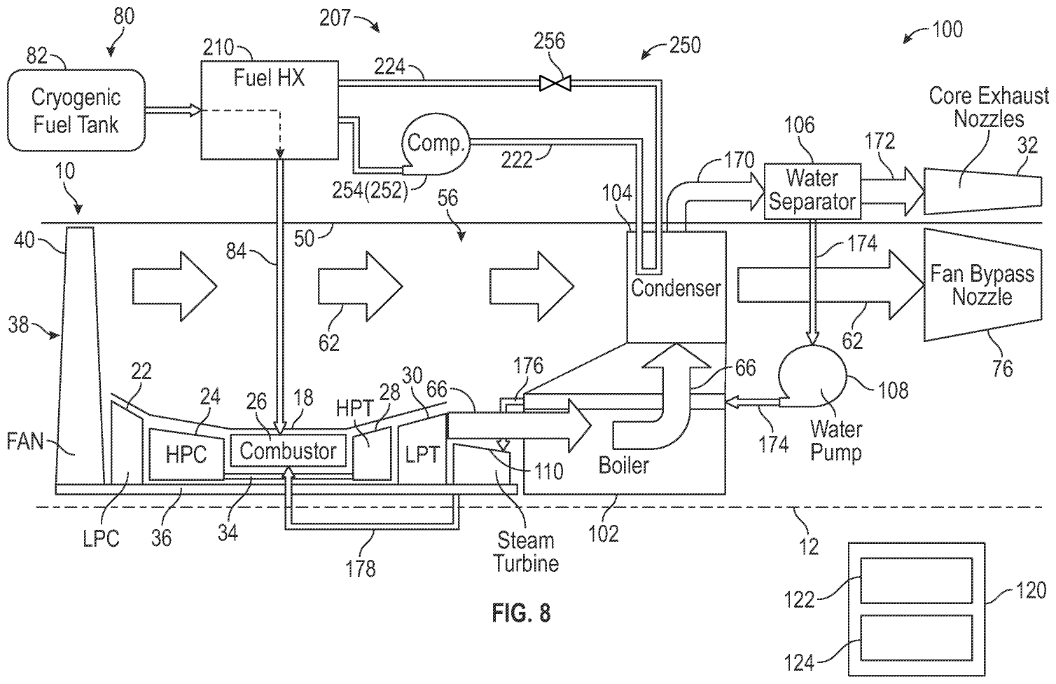

FIG. 8 is a schematic diagram of the turbine engine 10 and the steam system 100 of FIG. 1 having a thermal transport system 207, according to the present disclosure. For clarity with the other thermal transport systems discussed herein, the thermal transport system 207 of this embodiment will be referred to as an eighth thermal transport system 207. The eighth thermal transport system 207 is similar to the first thermal transport system 200 discussed above with reference to FIG. 2. The same reference numerals will be used for components of the eighth thermal transport system 207 that are the same as or similar to the components of the first thermal transport system 200 discussed above. The description of these components above also applies to this embodiment, and a detailed description of these components is omitted here.

The eighth thermal transport system 207 of this embodiment includes a heat transfer loop 250 that is similar to the heat transfer loop 220 having a supply line 222 and a return line 224 fluidly connecting the fuel heat exchanger 210 and the condenser 104. The description of the heat transfer loop 220 described above also applies to the heat transfer loop 250 of this embodiment.

The heat transfer fluid may be a single-phase fluid, but two-phase fluids may also be used. The eighth thermal transport system 207 of this embodiment uses a two-phase fluid. Suitable two-phase fluids include, for example, refrigerants, such as chlorofluorocarbon (CFC), hydrochlorofluorocarbon (HCFC), or hydrofluorocarbon (HFC). As the heat transfer fluid flows through the condenser 104, the fluid is heated and changes phase (i.e., evaporated) into a gas phase. The heat transfer fluid then flows in the gas phase to the fuel heat exchanger 210 through the supply line 222. In the fuel heat exchanger 210, the heat transfer fluid is cooled and condensed, changing phase back into the liquid phase.

The heat transfer loop 220 of this embodiment includes a heat transfer fluid pump 252 to induce the flow of the heat transfer fluid through the heat transfer loop 250 between the fuel heat exchanger 210 and the condenser 104. The heat transfer fluid pump 252 of this embodiment may be similar to the heat transfer fluid pump 226 discussed above and located at any suitable location within the heat transfer loop 250.

In some embodiments, the heat transfer fluid pump 252 may be located in the return line 224 to pump the heat transfer fluid in the liquid phase, but, in the embodiment shown in FIG. 8, the heat transfer fluid pump 252 is located in the supply line 222 and operates as a compressor. The heat transfer fluid pump 252 is thus referred to as a compressor 254 herein. With the compressor 254 located in the supply line 222, the compressor 254 also increases the pressure of the heat transfer fluid in the gas phase, super heating the heat transfer fluid. When the compressor 254 is used, the heat transfer loop 250 may also include an expansion valve 256 located in the return line 224 to maintain high-pressure on the inlet side (i.e., the fuel heat exchanger 210 side), while also expanding the liquid refrigerant and lowering the pressure on the outlet side (i.e., the condenser 104 side).

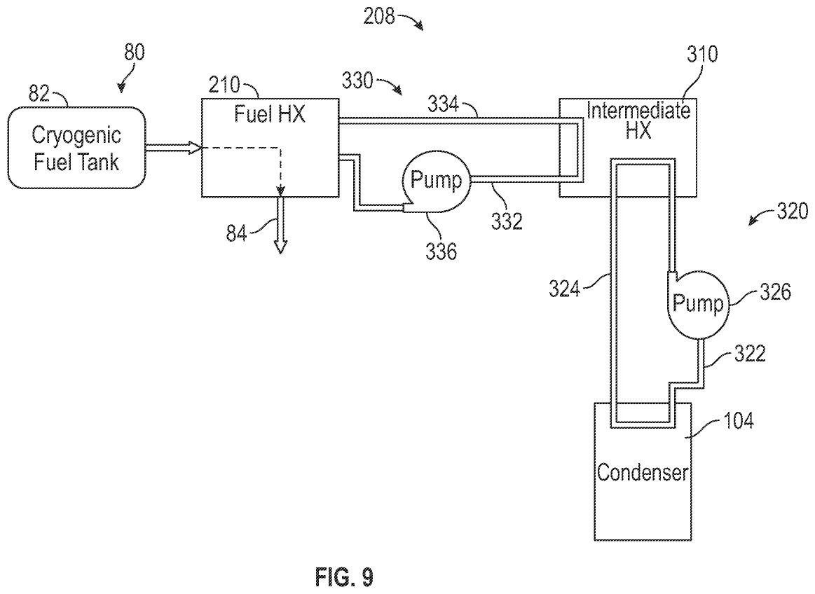

FIG. 9 shows a thermal transport system 208, according to the present disclosure that may be used in the turbine engine 10 and the steam system 100 discussed above. For clarity with the other thermal transport systems discussed herein, the thermal transport system 208 of this embodiment will be referred to as a ninth thermal transport system 208. The ninth thermal transport system 208 is similar to the first thermal transport system 200 discussed above with reference to FIG. 2. The same reference numerals will be used for components of the ninth thermal transport system 208 that are the same as or similar to the components of the first thermal transport system 200 discussed above. The description of these components above also applies to this embodiment, and a detailed description of these components is omitted here.

The combustion gases 66 (FIG. 2) entering the condenser 104 and the fuel 67 (FIG. 1) entering the fuel heat exchanger 210 may have a relatively large temperature difference, particularly when the fuel is a cryogenic fuel such as hydrogen fuel. The hydrogen fuel may have the cryogenic temperatures discussed above and the combustion gases 66 entering the condenser 104 during operation may have temperatures from five hundred degrees Fahrenheit (500° F.) (two hundred sixty degrees Celsius (260° C.) to one thousand six hundred degrees Fahrenheit (1600° F.) (eight hundred seventy-one degrees Celsius (871° C.), for example. It may be difficult to accommodate both these extreme cold conditions and extreme hot conditions with a single working fluid (i.e., heat transfer fluid), and, thus, in this embodiment, two working fluids (e.g., a first heat transfer fluid and a second heat transfer fluid) may be used.

The ninth thermal transport system 208 of this embodiment includes an intermediate heat exchanger 310. The intermediate heat exchanger 310 is fluidly connected to each of the condenser 104 and the fuel heat exchanger 210. The intermediate heat exchanger 310 may be any suitable heat exchanger, such as, for example, a tubular heat exchanger or a plate heat exchanger having flow paths for the first heat transfer fluid and the second heat transfer fluid. The intermediate heat exchanger 310 transfers heat from the first heat transfer fluid to the second heat transfer fluid as each fluid flows through the intermediate heat exchanger 310. As discussed further below, the first heat transfer fluid receives heat from the combustion gases 66 as it flows through the condenser 104 and the second heat transfer fluid transfers heat to the fuel 67 in the manner described above with reference to FIG. 2. The first heat transfer fluid is a working fluid selected for use in a high temperature environment such as those experienced in the turbine engine 10 and may include, for example, a silicon-based heat transfer fluid (e.g., Syltherm™ 800 or Syltherm™ XLT, each produced by Dow of Midland, Michigan, USA) or supercritical carbon dioxide. The second heat transfer fluid is in thermal contact with the cryogenic fuel and may be selected for use at these extremely low temperatures. Non-limiting examples include helium, nitrogen, or sulfur hexafluoride.

The intermediate heat exchanger 310 is fluidly connected to the condenser 104 by a first heat transfer loop 320. The first heat transfer loop 320 is similar to the heat transfer loop 220 discussed above and the discussion of the heat transfer loop 220 also apples to the first heat transfer loop 320. The first heat transfer loop 320 includes a supply line 322 similar to the supply line 222 discussed above. The supply line 322 is fluidly connected to each of the condenser 104 and the intermediate heat exchanger 310. The first heat transfer fluid flows through a fluid passage of the condenser 104 and, after being heated by the combustion gases 66, flows through the supply line 322 from the condenser 104 to the intermediate heat exchanger 310 where, as discussed above, heat is transferred from the first heat transfer fluid to the second heat transfer fluid. The first heat transfer loop 320 also includes a return line 324 fluidly connected to each of the intermediate heat exchanger 310 and the condenser 104. The first heat transfer fluid, after transferring heat to the second heat transfer fluid, flows through the return line 324 from the intermediate heat exchanger 310 to the condenser 104 where, as discussed above, heat is transferred from the combustion gases 66 to the second heat transfer fluid.

The first heat transfer loop 320 also includes a first heat transfer fluid pump 326. The first heat transfer fluid pump 326 may be similar to the heat transfer fluid pump 226 discussed above and the discussion of the heat transfer fluid pump 226 applies to this embodiment. The first heat transfer fluid pump 326 induces the flow of the first heat transfer fluid through the first heat transfer loop 320 between the condenser 104 and the intermediate heat exchanger 310. The first heat transfer fluid pump 326 may be located at any suitable location within the first heat transfer loop 320, but, in this embodiment, the first heat transfer fluid pump 326 is located in the supply line 322.

The intermediate heat exchanger 310 is fluidly connected to the fuel heat exchanger 210 by a second heat transfer loop 330. The second heat transfer loop 330 is similar to the heat transfer loop 220 discussed above and the discussion of the heat transfer loop 220 also apples to the second heat transfer loop 330. The second heat transfer loop 330 includes a supply line 332 similar to the supply line 222 discussed above. The supply line 332 is fluidly connected to each of the intermediate heat exchanger 310 and the fuel heat exchanger 210. The second heat transfer fluid flows through a fluid passage of the intermediate heat exchanger 310 and, after being heated by the first heat transfer fluid, flows through the supply line 332 from the intermediate heat exchanger 310 to the fuel heat exchanger 210 where, as discussed above, heat is transferred from the second heat transfer fluid to the fuel 67. The second heat transfer loop 330 also includes a return line 334 fluidly connected to each of the fuel heat exchanger 210 and the intermediate heat exchanger 310. The second heat transfer fluid, after transferring heat to the fuel 67, flows through the return line 334 from the fuel heat exchanger 210 to the intermediate heat exchanger 310 where, as discussed above, heat is transferred from the first heat transfer fluid to the second heat transfer fluid.

The second heat transfer loop 330 also includes a second heat transfer fluid pump 336. The second heat transfer fluid pump 336 may be similar to the heat transfer fluid pump 226 discussed above and the discussion of the heat transfer fluid pump 226 applies to this embodiment. The second heat transfer fluid pump 336 induces the flow of the second heat transfer fluid through the second heat transfer loop 330 between the intermediate heat exchanger 310 and the second heat transfer loop 330. The second heat transfer fluid pump 336 may be located at any suitable location within the second heat transfer loop 330, but, in this embodiment, the second heat transfer fluid pump 336 is located in the supply line 332.

The foregoing discussion includes various components in different embodiments of the thermal transport system. However, the components and features of the each of these thermal transport systems are not mutually exclusive and one or more of the components shown and described in one thermal transport system may be applied to another thermal transport system.

The turbine engine 10 of the embodiments discussed herein includes a steam system 100. The turbine engine 10 also includes a thermal transport system that may be used to transfer heat from the steam system 100 and, more specifically, the combustion gases 66, to the fuel 67 and to heat (i.e., or vaporize) the fuel 67. If cryogenic fuel is heated by being routed through the condenser 104, the condenser 104 risks icing due to the extreme cold of the cryogenic fuel. Using the water 174 and the thermal transport systems discussed herein mitigates the risk of icing in the condenser 104, where the ice could block the bypass air 62 from the fan 38, reducing thrust.

Further aspects of the present disclosure are provided by the subject matter of the following clauses.

A turbine engine for an aircraft. The turbine engine includes a fuel delivery assembly for fuel to flow therethrough. The turbine engine also includes a core turbine engine and a fan having a fan shaft coupled to the core turbine engine to rotate the fan shaft. The turbine engine includes a core air flow path for core air to flow therethrough, a combustor, a core shaft, and a turbine. The combustor is located in the core air flow path to receive compressed air and fluidly coupled to the fuel delivery assembly to receive the fuel from the fuel delivery assembly. The fuel is injected into the combustor to mix with the compressed air to generate a fuel and air mixture. The fuel and air mixture is combusted in the combustor to generate combustion gases. The turbine engine further includes a condenser, a fuel heat exchanger, and at least one heat transfer loop. The condenser is located downstream of the combustor to receive the combustion gases and to condense water from the combustion gases. The fuel heat exchanger is thermally coupled to the condenser to receive heat from the condenser. The fuel heat exchanger is located in the fuel delivery assembly to receive the fuel and to transfer the heat received from the condenser. The at least one heat transfer loop thermally couples the condenser with the fuel heat exchanger to transfer heat from the condenser to the fuel heat exchanger. The at least one heat transfer loop includes a heat transfer fluid flowing therethrough. The at least one heat transfer loop is fluidly connected to a passage of the condenser for the heat transfer fluid to receive heat from the combustion gases and thermally connected to the fuel heat exchanger for the heat transfer fluid to transfer heat from the heat transfer fluid to the fuel and to cool the heat transfer fluid.

The turbine engine of the preceding clause, further comprising a fuel tank holding fuel therein, the fuel delivery assembly being fluidly connected to the fuel tank to receive from the fuel tank.

The turbine engine of any preceding clause, wherein the at least one heat transfer loop is fluidly coupled to the fuel heat exchanger to transfer heat from the heat transfer fluid to the fuel and to cool the heat transfer fluid.

The turbine engine of any preceding clause, wherein the heat transfer fluid is one of helium, nitrogen, supercritical carbon dioxide, a silicon-based heat transfer fluid, or sulfur hexafluoride.

The turbine engine of any preceding clause, wherein the heat transfer fluid is a fluid other than water.

The turbine engine of any preceding clause, wherein the at least one heat transfer loop includes a supply line fluidly connected to each of the condenser and the fuel heat exchange to supply the fuel heat exchanger with the heat transfer fluid heated by the condenser, and a return line fluidly connected to each of the fuel heat exchange and the condenser to return the cooled heat transfer fluid from the fuel heat exchanger to the condenser.

The turbine engine of any preceding clause, further comprising a secondary heat exchanger fluidly connected to the fuel heat exchanger by a secondary input line to receive the cooled heat transfer fluid from the fuel heat exchanger, wherein the fuel heat exchanger includes a plurality of outlets, the return line being fluidly connected to one of the plurality of outlets and the secondary input line being fluidly connected to another one of the plurality of outlets.

The turbine engine of the preceding clause, wherein the secondary input line is connected to the fuel heat exchanger at a location upstream or downstream, relative to the flow of the heat transfer fluid, of the return line to provide the secondary heat exchanger with the heat transfer fluid at a temperature different from the temperature of the heat transfer fluid provided to the condenser.

The turbine engine of any preceding clause, wherein the at least one heat transfer loop includes a heat transfer fluid pump in fluid communication with the at least one heat transfer loop to induce the flow of the heat transfer fluid within the at least one heat transfer loop.

The turbine engine of any preceding clause, wherein the heat transfer fluid pump is located in the supply line.

The turbine engine of any preceding clause, wherein the heat transfer fluid is a two-phase heat transfer fluid and the heat transfer fluid pump is a compressor.

The turbine engine of any preceding clause, wherein the at least one heat transfer loop includes an expansion valve located in the return line.

The turbine engine of any preceding clause, wherein the at least one heat transfer loop includes an accumulator having a fluid reservoir to store the heat transfer fluid therein.

The turbine engine of any preceding clause, wherein the fluid reservoir has an adjustable volume for storing the heat transfer fluid.

The turbine engine of the preceding clause, wherein the volume of the fluid reservoir is actively adjustable by an actuator operable to adjust the volume of the fluid reservoir.

The turbine engine of any preceding clause, further comprising a controller operatively coupled to the actuator to move the actuator and to adjust the volume adjust the volume of the fluid reservoir.

The turbine engine of any preceding clause, wherein the controller is configured to receive an input and to adjust the volume of the fluid reservoir based on the received input.

The turbine engine of any preceding clause, further comprising a sensor that is communicatively coupled to provide the input to the controller.

The turbine engine of the preceding clause, wherein the sensor is a pressure sensor located to provide an input indicative of the pressure of the heat transfer fluid in the at least one heat transfer loop.

The turbine engine of any preceding clause, wherein the volume of the fluid reservoir is passively adjustable by a biasing member exerting a biasing force to adjust the volume of the fluid reservoir in response to changes in pressure within the fluid reservoir.

The turbine engine of any preceding clause, wherein the accumulator includes a movable diaphragm to adjust the volume of the fluid reservoir.

The turbine engine of any preceding clause, further comprising a secondary heat exchanger fluidly connected to the at least one heat transfer loop to exchange heat with the heat transfer fluid flowing through the at least one heat transfer loop.

The turbine engine of any preceding clause, wherein the secondary heat exchanger is fluidly connected in series with the condenser relative to the flow of the heat transfer fluid.

The turbine engine of any preceding clause, wherein the secondary heat exchanger is fluidly connected in parallel with the condenser relative to the flow of the heat transfer fluid.

The turbine engine of any preceding clause, wherein the at least one heat transfer loop includes a supply line and a return line. The supply line is fluidly connected to each of the condenser and the fuel heat exchange to supply the fuel heat exchanger with the heat transfer fluid heated by the condenser. The return line is fluidly connected to each of the fuel heat exchange and the condenser to return the cooled heat transfer fluid from the fuel heat exchanger to the condenser. The secondary heat exchanger is fluidly connected to one of the supply line or the return line by a secondary input line to receive the heat transfer fluid from the one of the supply line or the return line.

The turbine engine of any preceding clause, wherein the secondary input line is fluidly connected to the return line.

The turbine engine of any preceding clause, wherein the secondary heat exchanger is fluidly connected to the supply line by a secondary output line for the heat transfer fluid to flow from the secondary heat exchanger to the supply line.

The turbine engine of any preceding clause, further comprising at least one flow control valve controlling the flow of the heat transfer fluid.

The turbine engine of the preceding clause, wherein the at least one flow control valve is located in the heat transfer loop to control the flow of the heat transfer fluid in the heat transfer loop.

The turbine engine of any preceding clause, further comprising a secondary flow control valve located to control the flow of the heat transfer fluid into the secondary heat exchanger.

The turbine engine of any preceding clause, wherein the secondary flow control valve is located in the secondary input line.

The turbine engine of any preceding clause, further comprising a primary flow control valve located in the heat transfer loop downstream of the secondary input line to control the flow of the heat transfer fluid into the condenser.

The turbine engine of any preceding clause, further comprising a plurality of heat transfer loops thermally coupling the condenser with the fuel heat exchanger to transfer heat from the condenser to the fuel heat exchanger. The at least one heat exchanger is a first heat transfer loop of the plurality of heat transfer loops and the heat transfer fluid flowing through the first heat transfer loop is a first heat transfer fluid.

The turbine engine of any preceding clause, further comprising an intermediate heat exchanger that is fluidly coupled to first heat transfer loop to receive the first heat transfer fluid heated by the condenser, heat being transferred from the first heat transfer fluid to a second heat transfer fluid in the intermediate heat exchanger.

The turbine engine of the preceding clause, wherein the first heat transfer fluid and the second heat transfer fluid are different.

The turbine engine of any preceding clause, wherein the first heat transfer fluid is one of a silicon-based heat transfer fluid or supercritical carbon dioxide.

The turbine engine of any preceding clause, wherein the second heat transfer fluid is one of helium, nitrogen, or sulfur hexafluoride.

The turbine engine of any preceding clause, wherein the plurality of heat transfer loops includes a second heat transfer loop fluidly coupling the intermediate heat exchanger with the fuel heat exchanger, the second heat transfer flowing through the second heat transfer loop to transfer heat from the second heat transfer fluid to the fuel and to cool the heat transfer fluid.

The turbine engine of any preceding clause, wherein the first heat transfer loop includes a first fluid pump to induce the flow of the first heat transfer fluid through the first heat transfer loop.

The turbine engine of any preceding clause, wherein the first heat transfer loop includes a supply line to supply the first heat transfer medium to the intermediate heat exchanger from the condenser heat exchanger and a return line to supply the first heat transfer medium to the condenser from the intermediate heat exchanger.

The turbine engine of any preceding clause, wherein the first fluid pump is located in the supply line.

The turbine engine of any preceding clause, wherein the second heat transfer loop includes a second fluid pump to induce the flow of the first heat transfer fluid through the first heat transfer loop.

The turbine engine of any preceding clause, wherein the second heat transfer loop includes a supply line to supply the second heat transfer medium to the fuel heat exchanger from the intermediate heat exchanger and a return line to supply the second heat transfer medium to the intermediate heat exchanger from the fuel heat exchanger.

The turbine engine of any preceding clause, wherein the second fluid pump is located in the supply line.

The turbine engine of any preceding clause, wherein the fuel is a cryogenic fuel and the fuel tank is a cryogenic fuel tank for storing the fuel in the liquid phase.

The turbine engine of any preceding clause, wherein the fuel is hydrogen fuel.

The turbine engine of any preceding clause, further comprising a fuel bypass flow path selectively operable to redirect the fuel and to bypass the fuel heat exchanger.

The turbine engine of the preceding clause, further comprising a fuel bypass valve positioned in the fuel delivery assembly upstream of the fuel heat exchanger and selectively operable to redirect at least a portion of the fuel through the fuel bypass flow path.

The turbine engine of any preceding clause, further comprising a boiler and a steam turbine. The turbine is located downstream of the combustor to receive the combustion gases and to cause the turbine to rotate. The turbine is coupled to the core shaft to rotate the core shaft when the turbine rotates. The condenser is located downstream of the turbine to receive the combustion gases from the turbine. The boiler is fluidly connected to the condenser to receive the water and is fluidly connected to the combustor to receive the combustion gases and to boil the water to generate steam. The steam turbine is fluidly coupled to the boiler to receive the steam from the boiler and to rotate the steam turbine. The steam turbine is coupled to the core shaft to rotate the core shaft when the steam turbine rotates.

The turbine engine of any preceding clause, wherein the combustor is fluidly coupled to the steam turbine to receive the steam from the steam turbine and to inject the steam into the combustor.

The turbine engine of any preceding clause, wherein the core shaft is a low-pressure shaft and the turbine is a low-pressure turbine.

The turbine engine of any preceding clause, further comprising a low-pressure compressor connected to the low-pressure shaft to be driven by the low-pressure turbine and the steam turbine.

The turbine engine of any preceding clause, wherein the fan shaft is coupled to the low-pressure shaft to be driven by the low-pressure shaft.

The turbine engine of any preceding clause, comprising a bypass airflow passage, a first portion of air flowing into the fan and flowing through the bypass airflow passage as bypass air and a second portion of the air flowing into the fan and flowing through the core air flow path as core air, the condenser being located in the bypass airflow passage for bypass air to cool the combustion gases and to condense the water from the combustion gases.

The turbine engine of the preceding clause, wherein the combustor is fluidly coupled to the boiler to receive the steam from the boiler and to inject the steam into the combustor.

The turbine engine of any preceding clause, further comprising a water pump in fluid communication with the boiler to direct the flow of water into the boiler.

The turbine engine of any preceding clause, wherein the condenser generates an exhaust-water mixture when condensing the water from the combustion gases, the turbine engine further comprising a water separator located downstream of the condenser, the water separator separating the water from the exhaust-water mixture.

The turbine engine of the preceding clause, further comprising a water pump in fluid communication with the water separator to receive the water from the water separator and in fluid communication with the boiler to direct the flow of water into the boiler.

The turbine engine of any preceding clause, further comprising a water pump in fluid communication with the boiler to direct the flow of water into the boiler.

The turbine engine of any preceding clause, further comprising a high-pressure shaft, a high-pressure turbine, and a high-pressure compressor. The high-pressure turbine is positioned downstream of the combustor to receive the combustion gases and to rotate the high-pressure turbine. The high-pressure turbine is coupled to the high-pressure shaft to rotate the high-pressure shaft when the high-pressure turbine rotates. The high-pressure compressor is positioned in the core air flow path upstream of the combustor and downstream of the low-pressure compressor. The high-pressure compressor is driven by the high-pressure shaft to compress the core air flowing through the core air flow path and to generate the compressed air.

The turbine engine of any preceding clause, further comprising a bypass airflow passage for bypass air, the condenser positioned in the bypass airflow passage for bypass air to cool the combustion gases and to condense the water from the combustion gases, generating a cooled exhaust.

The turbine engine of any preceding clause, wherein the water separator is a cyclonic separator.

Although the foregoing description is directed to the preferred embodiments of the present disclosure, other variations and modifications will be apparent to those skilled in the art and may be made without departing from the spirit or the scope of the disclosure. Moreover, features described in connection with one embodiment of the present disclosure may be used in conjunction with other embodiments, even if not explicitly stated above.

1. A turbine engine for an aircraft, the turbine engine comprising:
a fuel delivery assembly for fuel to flow therethrough;
a core turbine engine including:
a core air flow path for core air to flow therethrough;
a combustor located in the core air flow path to receive compressed air and fluidly coupled to the fuel delivery assembly to receive the fuel from the fuel delivery assembly, the fuel injected into the combustor to mix with the compressed air to generate a fuel and air mixture, the fuel and air mixture being combusted in the combustor to generate combustion gases;
a core shaft; and
a turbine located downstream of the combustor to receive the combustion gases and to cause the turbine to rotate, the turbine coupled to the core shaft to rotate the core shaft when the turbine rotates;
a fan having a fan shaft coupled to the core turbine engine to rotate the fan shaft;
a condenser located downstream of the turbine to receive the combustion gases and to condense water from the combustion gases;
a fuel heat exchanger thermally coupled to the condenser to receive heat from the condenser, the fuel heat exchanger located in the fuel delivery assembly to receive the fuel and to transfer the heat received from the condenser; and
at least one heat transfer loop thermally coupling the condenser with the fuel heat exchanger to transfer the heat from the condenser to the fuel heat exchanger, the at least one heat transfer loop including a heat transfer fluid flowing therethrough, the at least one heat transfer loop fluidly connected to a passage of the condenser for the heat transfer fluid to receive heat from the combustion gases and thermally connected to the fuel heat exchanger for the heat transfer fluid to transfer heat from the heat transfer fluid to the fuel and to cool the heat transfer fluid.

2. The turbine engine of claim 1, further comprising:
a plurality of heat transfer loops thermally coupling the condenser with the fuel heat exchanger to transfer heat from the condenser to the fuel heat exchanger, the at least one heat transfer loop being a first heat transfer loop of the plurality of heat transfer loops and the heat transfer fluid flowing through the first heat transfer loop being a first heat transfer fluid; and
an intermediate heat exchanger that is fluidly coupled to first heat transfer loop to receive the first heat transfer fluid heated by the condenser, wherein heat is transferred from the first heat transfer fluid to a second heat transfer fluid in the intermediate heat exchanger.

3. The turbine engine of claim 2, wherein the plurality of heat transfer loops includes a second heat transfer loop fluidly coupling the intermediate heat exchanger with the fuel heat exchanger, the second heat transfer fluid flowing through the second heat transfer loop to transfer heat from the second heat transfer fluid to the fuel and to cool the heat transfer fluid.

4. The turbine engine of claim 1, further comprising:
a boiler fluidly connected to the condenser to receive the water and fluidly connected to the combustor to receive the combustion gases and to boil the water to generate steam; and
a steam turbine fluidly coupled to the boiler to receive the steam from the boiler and to cause the steam turbine to rotate, the steam turbine coupled to the core shaft to rotate the core shaft when the steam turbine rotates.

5. The turbine engine of claim 4, wherein the combustor is fluidly coupled to the steam turbine to receive the steam from the steam turbine and to inject the steam into the combustor.

6. The turbine engine of claim 4, wherein the core shaft is a low-pressure shaft and the turbine is a low-pressure turbine.

7. The turbine engine of claim 6, wherein the fan shaft is coupled to the low-pressure shaft to be driven by the low-pressure shaft, and the turbine engine further comprises a bypass airflow passage, a first portion of air flowing into the fan and flowing through the bypass airflow passage as bypass air and a second portion of the air flowing into the fan and flowing through the core air flow path as core air, the condenser located in the bypass airflow passage for bypass air to cool the combustion gases and to condense the water from the combustion gases.

8. The turbine engine of claim 1, wherein the at least one heat transfer loop is fluidly coupled to the fuel heat exchanger to transfer heat from the heat transfer fluid to the fuel and to cool the heat transfer fluid.

9. The turbine engine of claim 8, wherein the at least one heat transfer loop includes:
a supply line fluidly connected to each of the condenser and the fuel heat exchanger to supply the fuel heat exchanger with the heat transfer fluid heated by the condenser; and
a return line fluidly connected to each of the fuel heat exchanger and the condenser to return the cooled heat transfer fluid from the fuel heat exchanger to the condenser.

10. The turbine engine of claim 9, further comprising a secondary heat exchanger fluidly connected to the fuel heat exchanger by a secondary input line to receive the cooled heat transfer fluid from the fuel heat exchanger,
wherein the fuel heat exchanger includes a plurality of outlets, the return line being fluidly connected to one of the plurality of outlets and the secondary input line being fluidly connected to another one of the plurality of outlets.

11. The turbine engine of claim 10, wherein the secondary input line is connected to the fuel heat exchanger at a location upstream or downstream, relative to the flow of the heat transfer fluid, of the return line to provide the secondary heat exchanger with the heat transfer fluid at a temperature different from the temperature of the heat transfer fluid provided to the condenser.

12. The turbine engine of claim 9, wherein the at least one heat transfer loop includes a heat transfer fluid pump in fluid communication with the at least one heat transfer loop to induce the flow of the heat transfer fluid within the at least one heat transfer loop.

13. The turbine engine of claim 12, wherein the heat transfer fluid pump is located in the supply line.

14. The turbine engine of claim 13, wherein the heat transfer fluid is a two-phase heat transfer fluid and the heat transfer fluid pump is a compressor.

15. The turbine engine of claim 1, wherein the at least one heat transfer loop includes an accumulator having a fluid reservoir to store the heat transfer fluid therein.

16. The turbine engine of claim 15, wherein the fluid reservoir has an adjustable volume for storing the heat transfer fluid.

17. The turbine engine of claim 1, further comprising a secondary heat exchanger fluidly connected to the at least one heat transfer loop to exchange heat with the heat transfer fluid flowing through the at least one heat transfer loop.

18. The turbine engine of claim 17, wherein the secondary heat exchanger is fluidly connected in series with the condenser relative to the flow of the heat transfer fluid.

19. The turbine engine of claim 17, wherein the secondary heat exchanger is fluidly connected in parallel with the condenser relative to the flow of the heat transfer fluid.

20. The turbine engine of claim 19, wherein the at least one heat transfer loop includes:
a supply line fluidly connected to each of the condenser and the fuel heat exchanger to supply the fuel heat exchanger with the heat transfer fluid heated by the condenser; and
a return line fluidly connected to each of the fuel heat exchanger and the condenser to return the cooled heat transfer fluid from the fuel heat exchanger to the condenser,
wherein the secondary heat exchanger is fluidly connected to one of the supply line or the return line by a secondary input line to receive the heat transfer fluid from the one of the supply line or the return line.
